(19) United States
(12) Patent Application Publication
(10) Pub. No.: US 2019/0163839 A1
(43) Pub. Date: May 30, 2019

(54) COMPUTER-READABLE RECORDING MEDIUM, ESTIMATION METHOD AND ESTIMATION DEVICE

(71) Applicant: FUJITSU LIMITED, Kawasaki-shi (JP)

(72) Inventors: Yuri NAKAO, Kawasaki (JP); Kotaro Ohori, Sumida (JP); Hiroaki Yoshida, Isehara (JP); Takuya OHWA, Shinagawa (JP)

(73) Assignee: FUJITSU LIMITED, Kawasaki-shi (JP)

(21) Appl. No.: 16/194,701

(22) Filed: Nov. 19, 2018

(30) Foreign Application Priority Data
Nov. 30, 2017 (JP) 2017-231162

(51) Int. Cl. G06F 17/30

(52) U.S. Cl. CPC G06F 17/30976; G06F 17/30991; G06F 17/30867; G06F 17/30979

(57) ABSTRACT

A search device generates a preference trend based on content of a plurality of answers from a respondent for a plurality of inquiries each including a plurality of options. The search device, based on a log of content of representation items that are represented at the plurality of inquiries to the respondent, determines whether information that changes the representation items is to be represented. The search device generates an input candidate that changes the representation items according to a determining result based on the preference trend and displays the input candidate together with the representation items at the plurality of inquiries.

### CROSS-REFERENCE TO RELATED APPLICATION

This application is based upon and claims the benefit of priority of the prior Japanese Patent Application No. 2017-231162, filed on Nov. 30, 2017, the entire contents of which are incorporated herein by reference.

### FIELD

The embodiments discussed herein are related to a computer-readable recording medium, an estimation method and an estimation device.

### BACKGROUND

A technology to represent multiple options or items to a user and, based on an answer of choice of the user, search for a preference of the user is known. Furthermore, a technology to, in a system that searches for an item that is specified by a group of attribute from an item space, choose a group of attribute to represent an accurate number of items to the user is known.

Japanese National Publication of International Patent Application No. 2009-540475

Japanese Laid-open Patent Publication No. 2006-330858

It is known that there is a convergence process that is a process to change an index to be input to a system such that another item is represented to enable the user to check and sophisticate the current preference of the user in a process in which a user reaches true preference that the user wants.

FIG. 18 is a diagram illustrating the convergence process. FIG. 18 illustrates an example where an item is specified by an index of two dimensions that are transportation convenience and safety. As illustrated in FIG. 18, the user has increased importance of transportation convenience as a preference of the user but thinks more items can be searched by increasing or lowering importance of safety. In that case, by moving sub-indices other than a main index on which the user places importance clearly in various manners, the user sophisticates the content of input such that items more suitable to the user appear.

When the user changes the content of input such that a new item is represented by performing the convergence process, or the like, the content of input that is changed by the user may be insufficient for representation of another item. For example, even when the user wants to place importance on only the main index, no item with a high score of the main index may appear without changing the values of the sub-indices. In this case, it occurs a situation where the user thinks that the number of times the index is changed is insufficient and updates a list many times but the items are not changed and specifying a preference of the user does not progress.

Furthermore, the system could merely represent a new item that is irrelevant to the content of old inputs. In this case, as an item that is less relevant to the preference of the user resulting from repetitive inputs of indices until now is represented, the item is not useful as information for the user to check the preference of the user or as information for the system to specify a preference of the user.

### SUMMARY

According to an aspect of the embodiments, a non-transitory computer-readable recording medium stores therein a program that causes a computer to execute a process. The process includes generating a preference trend based on content of a plurality of answers from a respondent for a plurality of inquiries each including a plurality of options; based on a log of content of representation items that are represented at the plurality of inquiries to the respondent, determining whether information that changes the representation items is to be represented; generating an input candidate that changes the representation items according to the determining based on the preference trend; and displaying the input candidate together with the representation items at the plurality of inquiries.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary overall configuration of a system according to a first embodiment;

FIG. 2 is a functional block diagram illustrating a functional configuration of a search device according to the first embodiment;

FIG. 3 is a diagram illustrating exemplary information that is stored in a local government information DB;

FIG. 4 is a diagram illustrating exemplary information that is stored in a candidate DB;

FIG. 5 is a diagram illustrating exemplary specific display of items;

FIG. 6 is a diagram illustrating updating and ranking items;

FIG. 7 is a diagram illustrating a specific example of end points of a convex hull;

FIG. 8 is a diagram illustrating an example of specifying rankings of items in a group;

FIG. 9 is a diagram illustrating exemplary estimation of a preference trend;

FIG. 10 is a diagram illustrating exemplary determination of candidate vectors corresponding to a preference trend;

FIG. 11 is a diagram illustrating exemplary representation of a message suggesting a recommended direction;

FIG. 12 is a diagram illustrating exemplary representation of new items in the recommended direction;

FIG. 13 is a flowchart illustrating a flow of a process to display items, which is performed when a preference of the user is chosen;

FIG. 14 is a flowchart illustrating a flow of a process to represent new items;

FIG. 15 is a diagram illustrating exemplary comparison between the method according to the first embodiment and a general technology;

FIG. 16 is a diagram illustrating exemplary representation of items in a case where preferences are chosen randomly;

FIG. 17 is a diagram illustrating an exemplary hardware configuration; and

FIG. 18 is a diagram illustrating a convergence process.

### DESCRIPTION OF EMBODIMENTS

Preferred embodiments will be explained with reference to accompanying drawings. The embodiments do not limit the invention. The embodiments may be combined as long as no inconsistency is caused.

### [a] First Embodiment

Overall Configuration

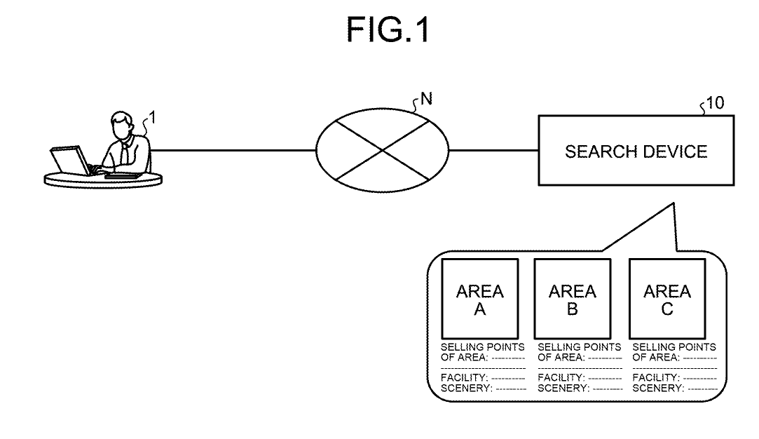

FIG. 1 is a diagram illustrating an exemplary overall configuration of a system according to the embodiment. As illustrated in FIG. 1, the system is a relocator matching system in which a user terminal 1 and a search device 10 are connected with each other via a network N. Various types of network, such as the Internet, can be used as the network N regardless whether the network is wired or wireless.

In the system, the user terminal 1 that a would-be relocator uses accesses the search device 100 in order to search for a relocation area. The search device 10 causes the user terminal 1 to display questions multiple times, estimates a preference of the would-be relocator (also referred to as user below) including important items and favor, and displays a local government that matches the preference on the user terminal 1. The present system is a system that implements matching between a would-be relocator and a local government that serves as a relocation site.

The relocator matching system will be exemplified to describe the first embodiment; however, embodiments are not limited thereto. Any system may be used as long as, for example, the system estimates a preference of a user according to answers to inquiries to the user.

The user terminal 1 is a computer device that the would-be relocator uses and is, for example, a personal computer, a mobile phone, a tablet terminal or a smartphone. The would-be relocator is an exemplary respondent.

The search device 10 is an exemplary server device that executes the above-described relocator matching. The search device 10 stores various logs including information on local governments, such as “Area A, Area B and Area C”, a log of searches by the would-be relocator, and information on estimation of a preference that the would-be relocator requests from a relocation site. The search device 10 represents inquiries (questions) to the would-be relocator multiple times, estimates a preference of the would-be relocator according to answers to the inquiries and represents a relocation site (local authority) that matches what the would-be relocator wants. In the first embodiment, the relocation site represented to the would-be relocator is also referred to as “item” below.

In general, when choosing an area to which a resident in an urban area relocates, what the would-be relocator wants in a relocation site has to be input to the system; however, it is not possible to take decrease in life convenience after relocation into consideration and thus it is not possible to express a true preference clearly. Thus, the search device 10 realizes a recommendation system that suggests an area appropriate to a would-be relocator to a local government based on the human psychology and executes information representation to the user to enable the would-be relocator to reach a true preference of the would-be relocator that the would-be relocator requests subconsciously or unconsciously.

In such a system, the search device 10 estimates a preference of the user based on answers (preference) to multiple inquiries containing multiple options.

Specifically, the search device 10 generates a preference trend that is a direction of preference of the user based on the content of the multiple answers from the user. Based on the log of content of items that are represented at the inquiries to the user, the search device 10 determines whether the displayed items have to be changed. According to the determination, the search device 10 generates input candidates that change representation items that are represented based on the preference trend and displays the input candidates together with the representation items at the inquiries.

For example, the user wants to verify whether the current choice of the user is correct by weighing another item close to the current preference of the user. Thus, in the process to reach a true preference, the user executes a process to check the current preference of the user and try to derive another item to sophisticate the preference (also referred to as convergence process).

The search device 10 predicts a direction the user is like to prefer from the log data (preference log) of the user and suggests having a preference in the direction to the user. Specifically, the search device 10 suggests candidates that the user would prefer to the user. In this manner, by suggesting more items while switching the representation items, the search device 10 puts changing the items displayed to the user and specifying a preference of the user forward together. In the first embodiment, narrowing down the suggested candidates is expressed as narrowing down directioning.

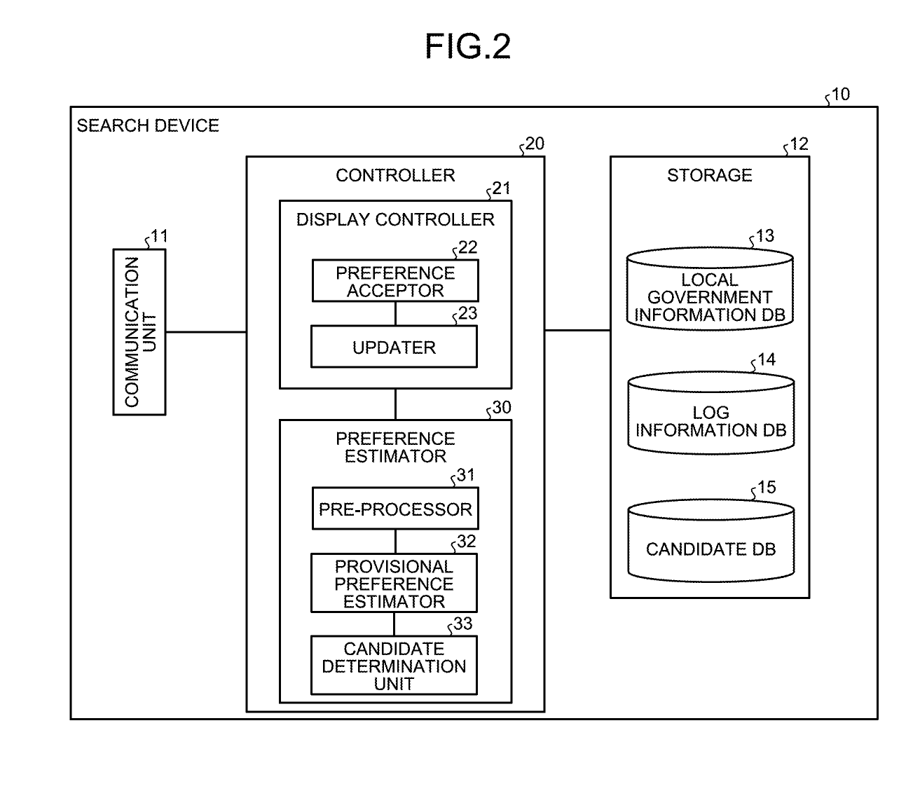

FIG. 2 is a functional block diagram illustrating a functional configuration of the search device 10 according to the first embodiment. As illustrated in FIG. 2, the search device 10 includes a communication unit 11, a storage 12 and a controller 20. The communication unit 11 is a processor that controls communication with other devices, such as the user terminal 1, and is, for example, a communication interface. For example, the communication unit 11 establishes communication with the user terminal 1 by a web browser and realizes communication of information on the web browser.

The storage 12 is an exemplary storage device that stores programs and data and is, for example, a memory and a hard disk. The storage 12 stores a local government information DB 13, a log information DB 14 and a candidate DB 25. The storage 12 is able to store various types of information on the user who is a would-be relocator, such as the name and the progress of estimation of preference, in a storage other than the aforementioned DBs.

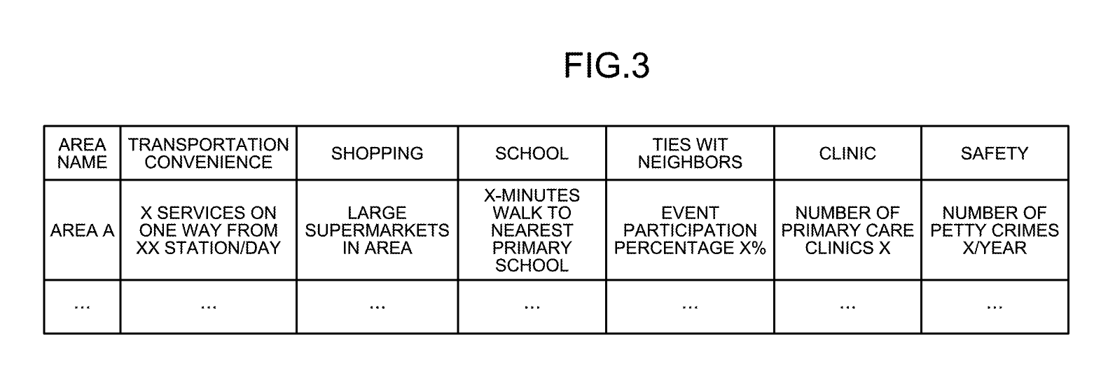

The local government information DB 13 is a database in which the search device 10 stores information on local governments that may match the user. FIG. 3 is a diagram illustrating exemplary information that is stored in the local government information DB 13. As illustrated in FIG. 3, the local government information DB 13 stores “area name, transportation convenience, shopping, school, ties with neighbors, hospital, and safety” in association with one another.

An “area name” stored in the local government information DB 13 is the name of an area of a local government serving as a relocation site. The aforementioned “transportation convenience, shopping, school, ties with neighbors, hospital, and safety” are selling points of the area and the number and content of the items listed herein can be changed optionally. “Transportation convenience” is information about convenience of transportation in the area, “shopping” is information on supermarkets, etc., in the area, “school” is information on schools set in the area. “Ties with neighbors” is information on ties with neighbors in the area, “hospital” is information on hospitals in the area, and “safety” is information on the number of crimes in the area, etc.

In the case illustrated in FIG. 3, in “AREA A”, there are X train services from XX station on one-way per day, there is a large supermarket in the area, and it takes X minutes to the nearest primary school on foot. FIG. 3 further indicates that, in “AREA A”, the percentage of participation in events is X%, the number of primary care clinics is X, and X petty crimes occur per year. The local government information DB 13 may store each item in a specific numeric value (for example, score).

The log information DB 14 is a database that stores various logs that occur in relocator matching. Specifically, the log information DB 14 stores inquiries from the search device 10, responses to the inquiries, attribute groups that the user inputs, the log of choices made by the user (preference log), etc.

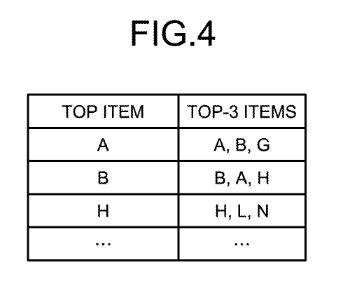

A candidate DB 15 is a database that stores candidates for items to be represented to the user that are generated by a preference estimator 30 to be described below. FIG. 4 is a diagram illustrating exemplary information that is stored in the candidate DB 15. As illustrated in FIG. 4, the candidate DB 15 stores “the top item and the top-3 items” in association with each other. “The top item” stored herein is an item that is determined as the item closest to the preference of the user and the “top-3 items” are the top-3 items that are estimated as items close to the preference of the user. The example represented in FIG. 4 indicates that, when the top item is A, the top-3 items are the three items A, B and C.

The controller 20 is a processor that controls the entire search device 10 and is, for example, a processor. The controller 20 includes a display controller 21 and the preference estimator 30. The display controller 21 and the preference estimator 30 are exemplary electronic circuits of the processor or exemplary processes that are executed by the processor.

The display controller 21 is a processor that executes control on displaying items according to the preference of the user and includes a preference acceptor 22 and an updater 23. For example, the display controller 21 displays a web screen on which items are represented on the user terminal 1 and accepts a preference of the user on the web screen. The display controller 21 changes the items to represent according to the accepted preference of the user and displays the web screen on which the items are represented on the user terminal 1.

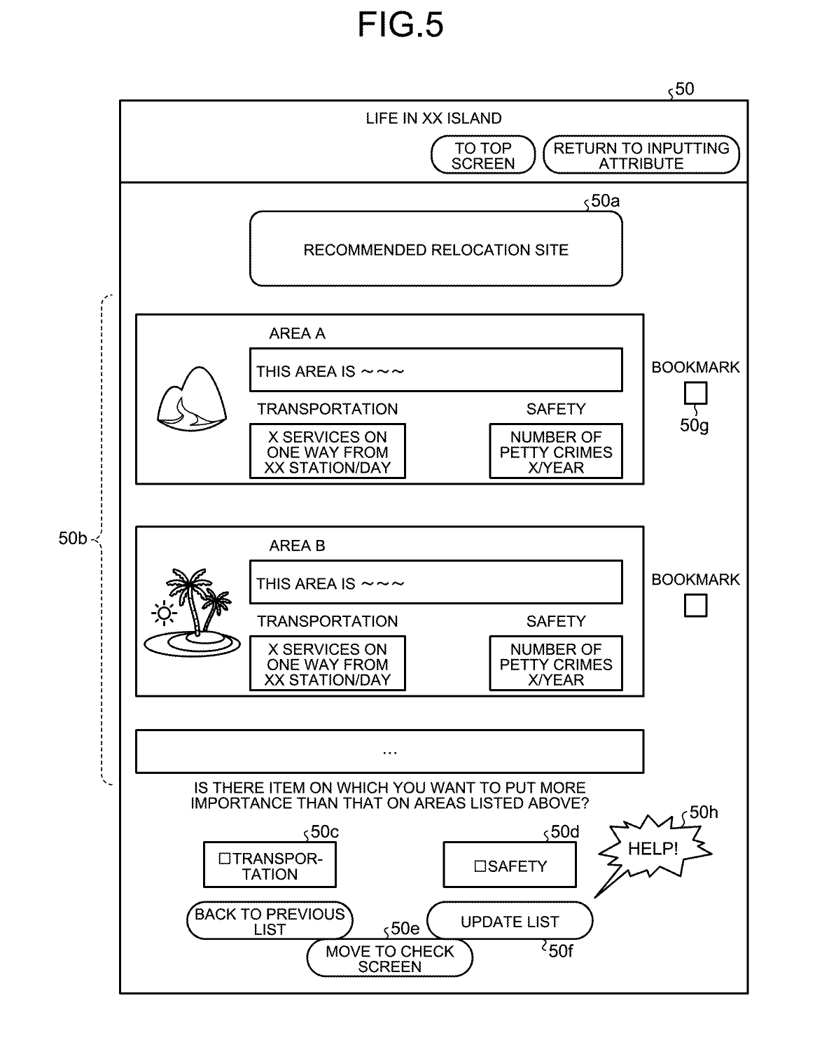

The preference acceptor 22 is a processor that accepts a preference of the user on the web screen on which the items are displayed. FIG. 5 is a diagram illustrating exemplary specific display of items. An area 50a of a screen 50 illustrated in FIG. 5 is an area to display the title of the web screen and display an attribute that is chosen by the user or an item on which the user places importance. An area 50b is an area on which a list of local governments that match the user is displayed, that is, an area on which a top-N list of items is displayed.

A button 50c and a button 50d are buttons to accept choice of an item on which importance is placed and, the button 50c is chosen to place importance on transportation convenience and the button 50d is chosen to place importance on safety. A button 50e is a button to move to a check screen and is pressed when a satisfactory local government is searched for. A button 50f is a button to request updating the list. A button 50g is a button for addition to the bookmark and is a button for temporarily storing information for the user to use the information to compare and weigh a relocation site. A button 50h is a trigger to execute a process performed by the preference estimator 30 to be described below and is an exemplary trigger of a process that is executed when it is assumed that the user has a trouble in choosing a preference.

For example, when the button 50c is chosen on the web screen illustrated in FIG. 5 and the button 50f to update the list is pressed, the preference acceptor 22 determines that importance is placed on “transportation convenience” as a preference of the user. More specifically, the preference acceptor 22 makes a determination “transportation convenience +” and determines that an item with transportation convenience equal to or higher than a given value as an item to be represented and notifies the updater 23 of the determination. An example where a space of two dimensions that are “transportation convenience” and “safety” is used as a preference of the user will be described as the first embodiment; however, embodiments are not limited thereto, and the number of attributes serving as a preference can be increased or reduced optionally.

The updater 23 is a processor that updates the items to represent according to the preference that is accepted by the preference acceptor 22. Using the web screen, etc., the updater 23 chooses items according to the preference of the user that is accepted before representation of items and represents the chosen item to the user.

Specifically, the updater 23 specifies a position that is preferred by the user in a preference space that is determined by transportation convenience (vertical axis) and safety (horizontal axis) and specify a vector from the origin to the preferred position (preference vector The updater 23 determines rankings of items to represent according to the sequence obtained when the items are orthogonally projected on a straight line extended in parallel with the preference vector (β) in an item space that is determined by transportation convenience (vertical axis) and safety (horizontal preference). In other words, as for the rankings of the items, the rankings and scores of the items are determined by only the ratio of the preference vector (β).

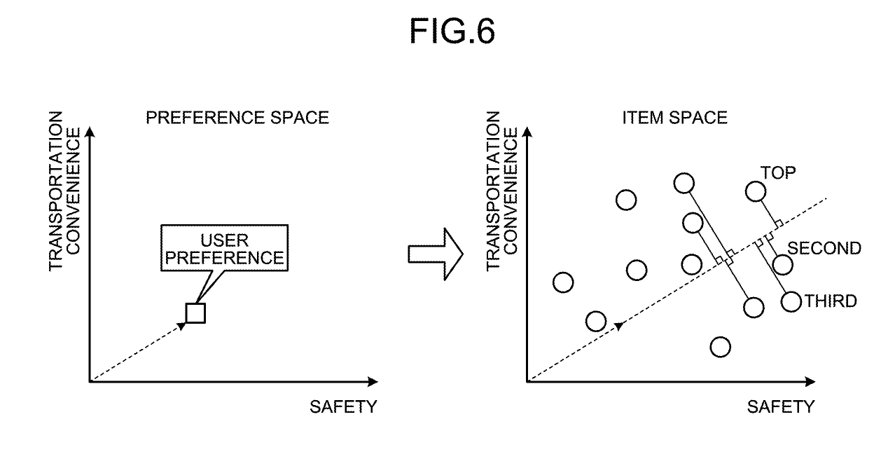

FIG. 6 is a diagram illustrating updating and ranking items. As illustrated in FIG. 6, the updater 23 determines a position of a user preference in the preference space according to the result of choosing a preference of the user and specifies the preference vector β to the position. The updater 23 then positions the preference vector β in the item space and extends the preference vector β. The updater 23 then draws a normal from each item to the extended preference vector β and represents N items in the order in which the items appear when the normals are counted from the other side of the origin as the top-N list on the web screen to the user. In the example illustrated in FIG. 6, the updater 23 specifies the top-3 items and displays the top-3 items as the top-3 list in the area 50b of the screen 50 in FIG. 5.

The preference estimator 30 is a processor that, when the user changes the index, suggests a direction in which more new items appear easily and that seems to be close to the true preference of the user. The preference estimator 30 includes a pre-processor 31, a provisional preference estimator 32 and a candidate determination unit 33. Specifically, the preference estimator 30 inhibits the user from entering the convergence process and detects whether the user is in the mode of the convergence process in order to end the convergence process of the user early. When the user is in the mode of the convergence process, the preference estimator 30 not only suggests a single index on which the user is likely to place importance but also represents how to move the index that has to be changed. The provisional preference estimator is an exemplary generator and the candidate determination unit 33 is an exemplary determination unit and an exemplary display controller.

The pre-processor 31 is a processor that executes pro-processing. Specifically, the pre-processor 31 previously calculates multiple preference vectors and rankings of items obtained when each of the preference vectors is chosen and stores the multiple preference vectors and the rankings in the candidate DB 15. For example, using the characteristics of the item space, the pre-processor 31 specifies items each serving as an end point of a convex hull of the item space as items that may be the top item. The pre-processor 31 also specifies which items appear as the top-N items when each end point is the top item and saves the items in the candidate DB 15.

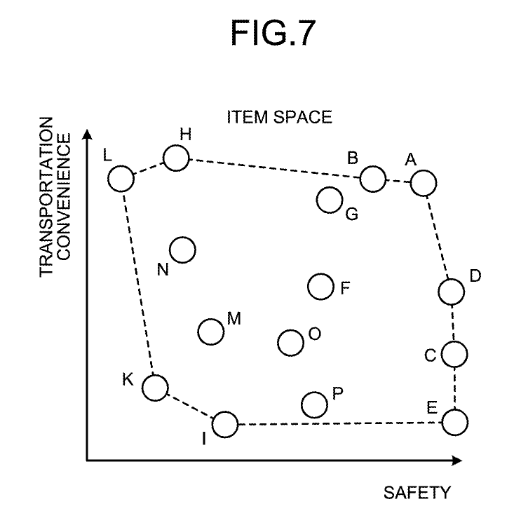

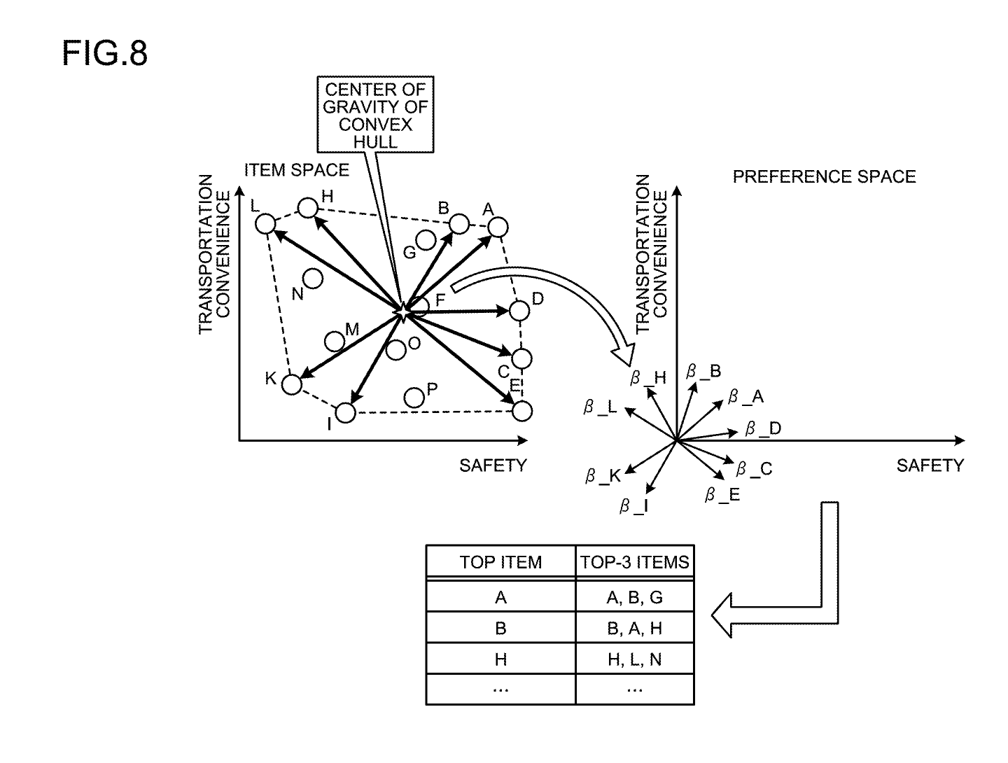

Specific descriptions will be given using FIGS. 7 and 8. FIG. 7 is a diagram illustrating a specific example of end points of a convex hull. FIG. 8 is a diagram illustrating an example of specifying rakings of items in a group. As illustrated in FIG. 7, the pre-processor 31 maps items (white circles) onto the item space. The pre-processor 31 then generates a convex hull in the item space and specifies Item A, Item, B, Item H, Item L, Item K, Item I, Item E, Item C, and Item D as items that can be the top item among the items to be represented.

As illustrated in FIG. 8, the pre-processor 31 saves, in the preference space, vectors extending from the center of gravity of the convex hull to the respective end points as vectors each of which makes the item of the end point the top item. For example, the pre-processor 31 generates a candidate vector β_A to Item A, a candidate vector β_B to Item B, a candidate vector β_H to Item H, a candidate vector β_L to Item L, etc., with respect to the respective end points in the preference space.

Thereafter, the pre-processor 31 ranks the items according to the same method as that illustrated in FIG. 6 with respect to each candidate vector and specifies the top-3 items. For example, the pre-processor 31 draws a normal from each item to the candidate vector β_A to Item A and specifies Item A, Item B and Item X as the top-3 items. The pre-processor 31 then registers “Item A and Items A, B and G” as “the top item and the top-3 items” in the candidate DB 15.

The provisional preference estimator 32 is a processor that estimates a trend of choice of the user (also referred to as “preference trend” or “provisional preference” below) that is derived from the preference log of the user. Specifically, the provisional preference estimator 32 executes estimation of a preference trend when, when updating the items according to the preference of the user, the represented items do not change, the represented items do not change a given number of times successively, or the button 50h on the web screen illustrated in FIG. 5 is pressed.

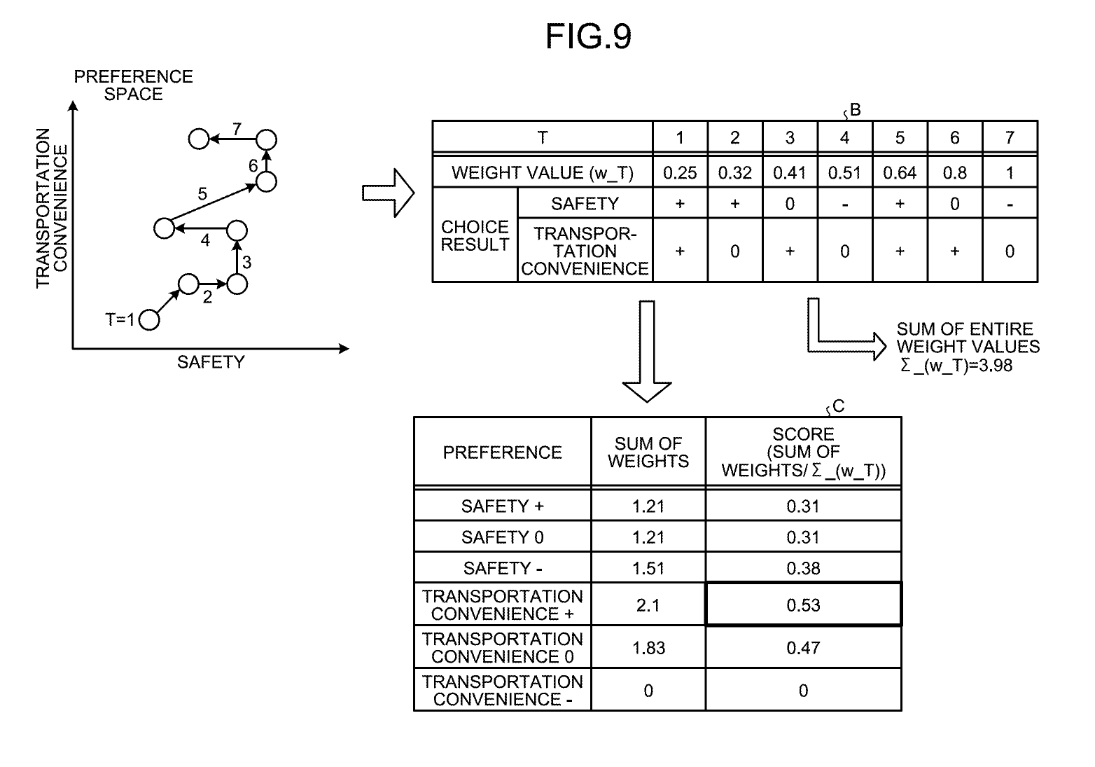

FIG. 9 is a diagram illustrating exemplary estimation of a preference trend. FIG. 9 represents an example where a preference trend is estimated in a state where choosing a preference has been already carried out seven times. A case where the importance of an attribute, such as safety, is increased from the previous one is represented as “+ (plus)” and a case where the importance is decreased is represented as “− (minus)”, and a case where the importance is not changed is represented as “0”.

First of all, in a case where choosing a preference has been carried out seven times, the provisional preference estimator 32 applies a weight value (w_T) to each of the first (T=1) to seventh (T=7) preferences to increase the new preference (see (B) in FIG. 9). For example, as illustrated in FIG. 9, the provisional preference estimator 32 applies a weight value “0.25” to the first preference “safety +and transportation convenience +”, applies a weight value “0.32” to the second preference “safety + and transportation convenience 0”, and applies a weight value “0.41” to the third preference “safety 0 and transportation convenience +”. Similarly, the provisional preference estimator 32 applies a weight value “0.51” to the fourth preference “safety − and transportation convenience 0”, applies a weight value “0.64” to the fifth preference “safety + and transportation convenience +”, and applies a weight value “1” to the seventh preference “safety − and transportation convenience 0”.

The provisional preference estimator 32 extracts each trend of preference from the list (B) in FIG. 9 and calculates a score to each trend (see (C) in FIG. 9). For example, the provisional preference estimator 32 calculates a sum “1.21” of the first, second and fifth weights applied for the execution of choosing the preference “safety +”, calculates a sum “1.21” of the third and sixth weights applied for the execution of choosing the preference “safety 0”, and calculates a sum “1.51” of the fourth and seventh weights applied for the execution of choosing the preference “safety −”. In the same manner, the provisional preference estimator 32 calculates a sum “2.1” of the first, third, fifth and sixth weights applied for the execution of choosing the preference “transportation convenience +”, calculates a sum “1.83” of the second, fourth and seventh weights applied for the execution of choosing the preference “transportation convenience 0”, and calculates a sum “0” as choosing the reference “transportation convenience −” is not executed.

The provisional preference estimator 32 divides the weight of each preference by the sum of weights “3.93” to calculate a score of each preference. For example, the provisional preference estimator 32 calculates “2.1/3.93=0.53” as a score of the preference “transportation convenience +”. The provisional preference estimator 32 estimates the preference “transportation convenience +” with a score equal to or larger than a threshold “0.5” that can be set optionally among the scores of the respective preferences as a preference trend and adds the preference trend to the candidate determination unit 33. In other words, the provisional preference estimator 32 estimates that “the user wants to place much importance on transportation convenience”.

The candidate determination unit 33 is a processor that determines whether there is a candidate vector that is able to represent a better item in a direction of preference trend. Specifically, the candidate determination unit 33 determines whether there is another preference vector in a direction that is specified as a preference trend from the current preference vector, using the candidate DB 15 and the method described with reference to FIG. 8. When there is another preference vector in the direction of preference trend, the candidate determination unit 33 refers to the candidate DB 15 and specifies a preference vector that changes the current representation items and the top-3 items change more. The candidate determination unit 33 then represents the items corresponding to the specified preference vector to the user.

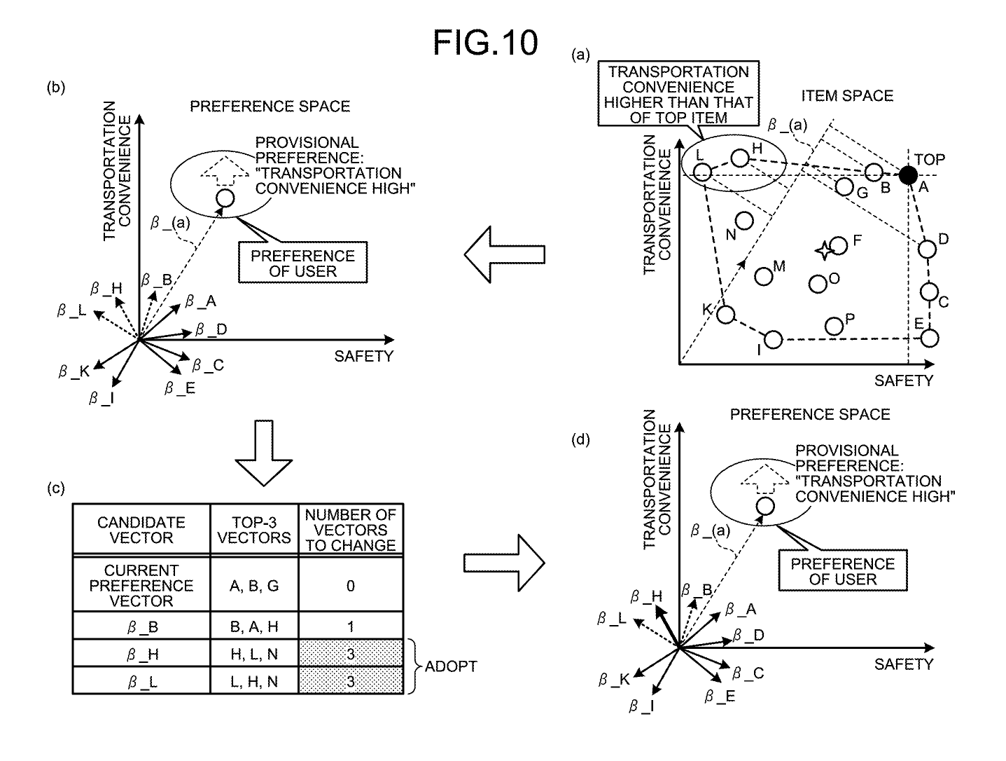

FIG. 10 is a diagram illustrating exemplary determination of candidate vectors corresponding to a preference trend. Assume that, as illustrated in FIG. 10(a), currently, the candidate vector of the user is β_(a) and Item A, Item B and Item G are represented to the user in the order the items appear in this sentence. In this state, as the preference trend of the user is “transportation convenience +”, it can be assumed that Item H and Item L are new top candidates.

Accordingly, as illustrated in (b) in FIG. 10, in the preference space, the candidate determination unit 33 specifies the three candidate vectors β_B, β_H and β_L as candidate vectors that increases transportation convenience more than the current preference vector does.

The candidate determination unit 33 specifies the top three items corresponding to the choice of the specified candidate vector from from the candidate DB 15 and specifies a difference in number from the three items that are currently represented. For example, as illustrated in FIG. 10(c), the candidate determination unit 33 specifies that the currently displayed items are “A, B and G”, the items corresponding to the choice of the candidate vector β_B are “B, A and H”, the items corresponding to the choice of the candidate vector β_H are “H, L and M”, and the items corresponding to the choice of the candidate vector β_L are “H, H and N”.

The candidate determination unit 33 specifies that one of the represented items changes when the candidate vector β_B is chosen, the three represented items change when the candidate vector β_H is chosen, and the three represented items change when the candidate vector β_L is chosen. As a result, the candidate determination unit 33 determines the candidate vector β_H and the candidate vector β_L that change the number of items the most among the three candidate vectors, which are candidates, as candidates to be adopted.

As illustrated in (d) in FIG. 10, the candidate determination unit 33 then adopts, from the candidate vector β_H and the candidate vector β_L, the candidate vector β_H that is a vector with the highest similarity in cosine (the smallest angle) to the current candidate vector as a direction in which the user changes the preference.

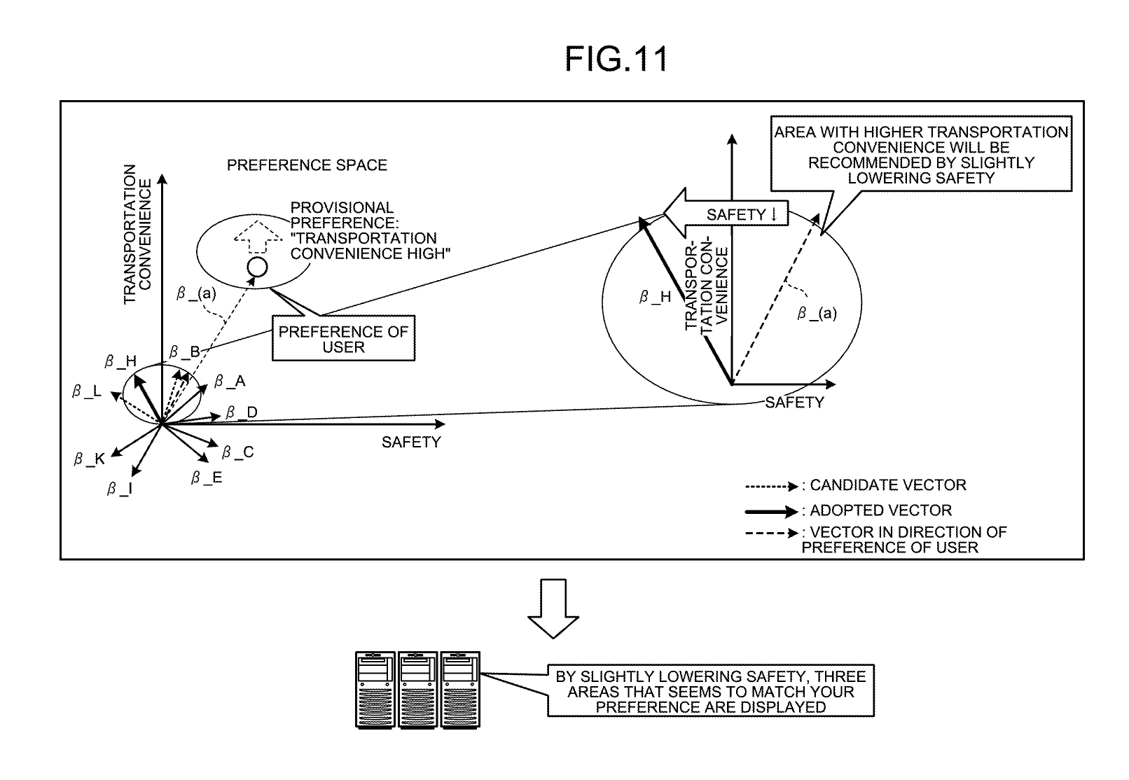

In other words, as illustrated in FIG. 11, “transportation convenience high” in the vector of direction of preference of the user, which is specified from preference of the user in the past, and the vector is the candidate vector β_H that is adopted by the candidate determination unit 33. As a result, the candidate determination unit 33 is able to specify that, in order to change representation of items while maintaining the preference of the user, an area (item) with high transportation convenience can be proposed by slightly lowering safety. Accordingly, as illustrated in FIG. 11, the candidate determination unit 33 displays a message like “By slightly lowering safety, three areas that seem to match your preference are displayed” on the web screen. FIG. 11 is a diagram illustrating exemplary representation of a message suggesting a recommended direction.

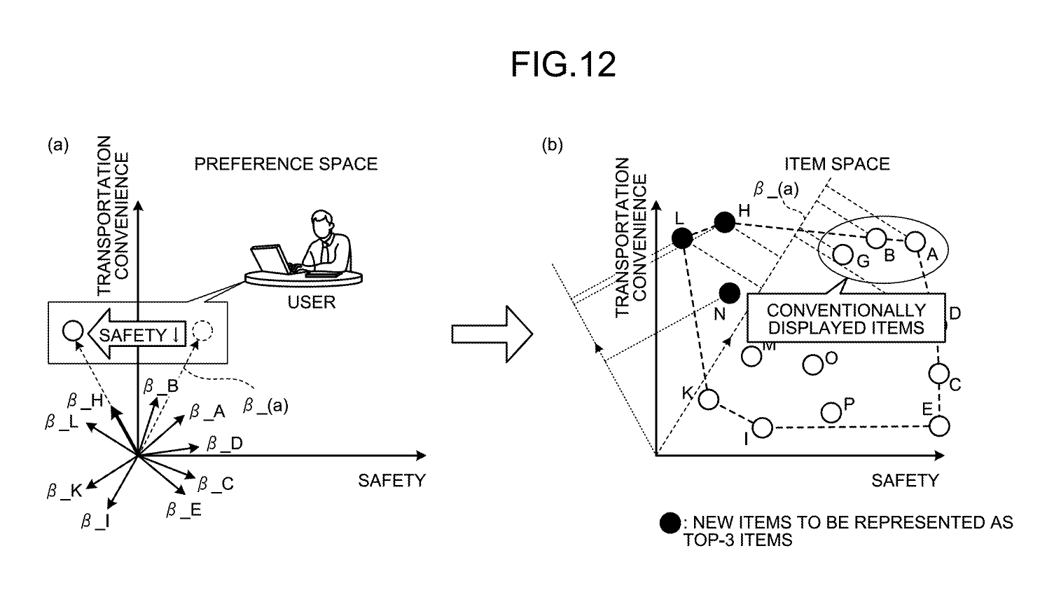

Thereafter, when the displayed message, or the like, is chosen by the user, the candidate determination unit 33 represents new items corresponding to the recommended direction to the user. FIG. 12 is a diagram illustrating exemplary representation of new items in the recommended direction. As illustrated in FIG. 12(a), the candidate determination unit 33 changes the preference vector of preference of the user from the current vector to the candidate vector β_H in the preference space. As illustrated in FIG. 12(b), the candidate determination unit 33 specifies Items H, L and N as the top items based on the candidate vector β_H in the item space and displays Items H, L and N as the top-3 list in the area 50b of the screen 50 in FIG. 5. As a result, as illustrated in FIG. 12(b), the candidate determination unit 33 is able to represent, to the user, the web screen on which display is changed to the new Items H, L and N from Items A, B and G that have been displayed.

Process Flow

Flows of the respective above-described processes will be described. The process performed when a preference of the user is chosen and a process to represent a new item will be described.

Process Performed when Preference of User is Chosen

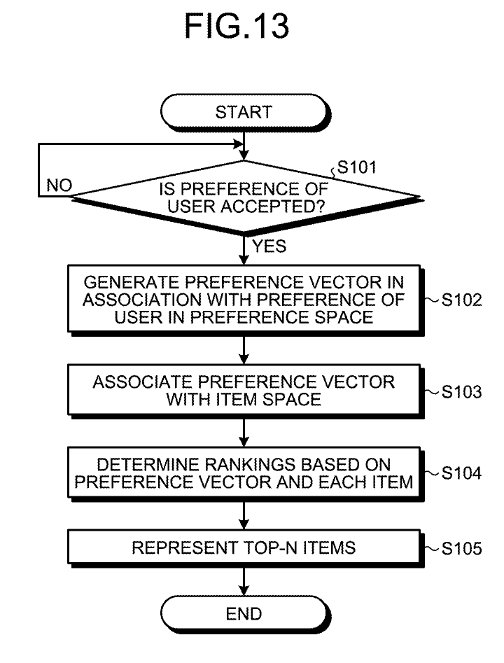

FIG. 13 is a flowchart illustrating a flow of a process to display items, which is performed when a preference of the user is chosen. As illustrated in FIG. 13, when the preference accepter 22 accepts a preference of the user (YES at S101), the updater 23 associates the preference of the user with a preference space and generates a preference vector (S102).

The updater 23 then associates the preference vector with an item space (S103) and, based on the preference vector and each item, determines rankings of the represented items in the item space (S104). The updater 23 then represents the top-N items to the user (S105).

Process to Represent New Items

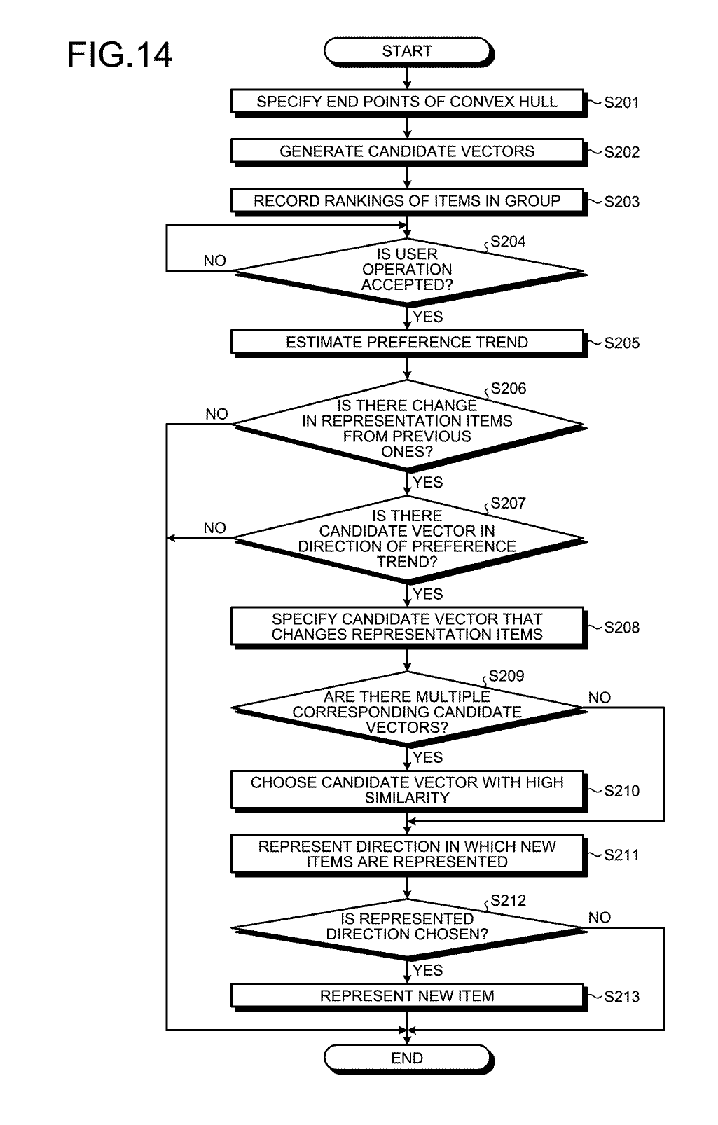

FIG. 14 is a flowchart illustrating a flow of a process to represent new items. A flow from pre-processing to determination of candidates will be described as an example; however, each process may be executed at different timing.

As illustrated in FIG. 14, the pre-processor 31 plots each item in the item space and specifies end points of a convex hull from the items (S201). The pre-processor 31 then generates candidate vectors each of which is a vector extended from the center of gravity of the convex hull to each of the end points (S202). The pre-processor 31 then records the rankings of items in the group with respect to each candidate vector (S203).

In other words, the pre-processor 31 generates vectors (candidate vectors) that enables the respective end points to be the top and simultaneously records the sets of rankings of the items in the group each of which is obtained when each of the end points is the top. In this case, which items appear in the top-N items when each end point is the top is specified and the items are saved in the candidate DB 15.

When a user operation to request representation of new items is accepted (YES at S204), the provisional preference estimator 32 reads the preferences log of the user from the log information DB 14 and estimates a preference trend based on the preference log (S205).

The candidate determination unit 33 determines whether the representation items do not change by the update of the list of the items that are represented for the previous time (S206). When the representation items with a given number of representation items changed are displayed (NO at S206), the candidate determination unit 33 ends the process and the process in FIG. 13 is executed.

On the other hand, when the representation items do not change (YES at S206), the candidate determination unit 33 determines whether there is a candidate vector that enables representation of better items in the direction of the preference trend (S207). When there is not a corresponding candidate vector (NO at S207), the candidate determination unit 33 ends the process and the process in FIG. 13 is executed.

On the other hand, when there is a corresponding candidate vector (YES at S207), the candidate determination unit 33 calculates how many items among the top N list are changed by the candidate vector and specifies a candidate vector that changes the largest number of items (S208).

When there are multiple corresponding candidate vectors (YES at S209), the candidate determination unit 33 calculates similarities in cosine with the current preference vector and specifies a candidate vector with high similarity (S210). On the other hand, when there are not multiple corresponding candidate vectors (NO at S209), the candidate determination unit 33 executes S211 without executing S210.

The candidate determination unit 33 represents a direction to the adopted candidate vector and a message like “Direction in which new X items will appear” to the user (S211). When the represented direction or the represented message is chosen (YES at S212), the candidate determination unit 33 represents corresponding new items to the user (S213). On the other hand, when neither the represented direction nor the represented message is chosen (NO at S212), the process ends and the process in FIG. 13 is executed.

Effect

As described above, when the preference trend of the user becomes apparent, the search device 10 determines whether to represent information to change the displayed items and represents items that are along the preference trend of the user but were not chosen in the past. Accordingly, the search device 10 is able to store the choice of the user in the past and change the represented items. As a result, the search device 10 is able to meet the request to change the displayed items to the user and move specifying a preference forward.

When the log of choices of items made by the user accumulates, the search device 10 is able to represent content of input change enabling representation of new items along the preference of the user. During the process in which the user chooses a preference, when the preference trend of the user becomes apparent, the search device 10 is able to specify a direction of preference in which new items tend to appear while utilizing the trend. The search device 10 represents preference trend information and content of input change for which a direction in which new items tend to appear is taken into consideration and thus new items to be represented serve as information useful in the convergence process performed by the user and in specifying a preference by the system.

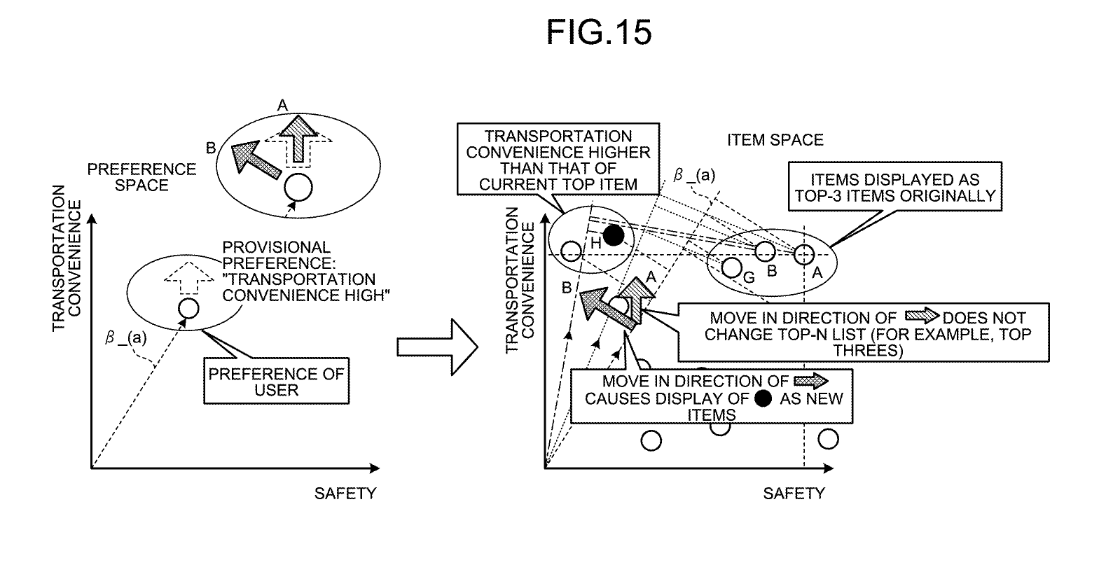

FIG. 15 is a diagram illustrating exemplary comparison between the method according to the first embodiments and a general technology. As illustrated in the preference space in FIG. 15, when “transportation convenience high” is specified as a preference trend, a general user searches for an item in a direction A in which only transportation convenience increases. In this case, as illustrated in the item space in FIG. 15, even when the preference vector is moved in the direction A from the current preference vector β_(a), the displayed items (A, B and G) are the same as the current items (A, B and G) and do not change.

On the other hand, when “transportation convenience high” is specified as a preference trend, it can be specified that there is a useful item in a direction B. In this case, as illustrated in the item space in FIG. 15, by moving a preference vector from the current preference vector β_(a) in the direction B, it is possible to display Item H different from the current items. Accordingly, it is possible to represent an item that is difficult for the user to search for by himself/herself and thus shorten the time taken by the user to perform the convergence process.

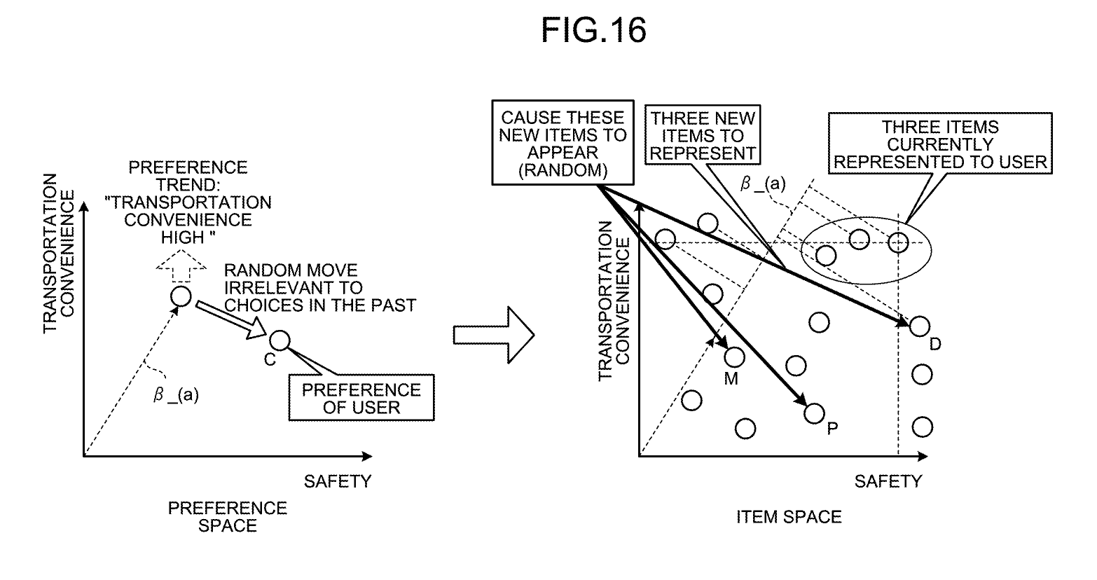

FIG. 16 is a diagram illustrating exemplary representation of items in a case where a preference is chosen randomly. As illustrated in the preference space in FIG. 16, when “transportation convenience high” is specified as a preference trend, the preference of the user could be moved by random movement irrelevant to choices in the past. In this case, as illustrated in the item space in FIG. 16, the randomly chosen items (D, P and M) are represented to the user.

In this method, as the represented items change but items irrelevant to the preference of the user are displayed, not information useful to the user but, on the contrary, the convergence process may be promoted resultantly. Furthermore, the log in which the items that are chosen randomly as described above is information unnecessary to estimate a preference trend of the user and the log could cause deterioration in accuracy in estimating a preference trend. Accordingly, the random-representation method is far from an effective method.

### [b] Second Embodiment

The embodiment of the present invention has been described. The invention may be carried out in various different modes in addition to the above-described embodiment.

Item on which importance is placed (preference item)

The first embodiment has been described by exemplifying mapping onto the space of two dimensions that are transportation convenience and safety; however, embodiments are not limited thereto. Transportation convenience, shopping, school, ties with neighbors, hospital and safety represented in FIG. 3, etc., may be combined optionally and used. For example, when all of them are used, an inquiry is made about any of the six items as an item on which importance is placed, the item is mapped onto a six-dimensional space, and the above-described process is executed. In the first embodiment, the example where the top-3 list is displayed has been described; however, the setting may be changed optionally to, for example, top fours.

Weight Value

The above-described exemplary setting of weight values is an example only and the setting may be changed optionally. Furthermore, it is also possible to set a value by simple increase such that the weight on a new preference is the largest or set a value regularly. In the first embodiment, the example where a preference with a score equal to or larger than the threshold (0.5) is chosen has been described; however, embodiments are not limited thereto. For example, a preference with the highest score may be chosen.

Determination on Necessity to Change Representation

In the first embodiment, the example where, when the user presses the button 50h, estimating a preference trend and changing the representation items are executed has been described; however, embodiments are not limited thereto. For example, when the log of representation items is stored and changing items smaller in number than a given number, such as one, succeeds a given number of times, such as three times, sequentially, estimating a preference trend and changing the represented items may be executed.

When the number of times the user chooses a preference exceeds a threshold (for example, three times) or when a sum of weight values exceeds a given value (for example, 3), automatic execution may be performed. When the user presses the button 50h and the above-described condition is met, changing the representation items, etc., may be executed.

In the first embodiment, the example where a candidate vector that changes the top item is chosen has been described; however, embodiments are not limited thereto. For example, a candidate vector that changes the second and following items may be chosen and a candidate vector resulting in matching of at least one item may be chosen. The exemplary calculation of similarity is an example only, and another known calculation method may be used.

Content of Representation

The content of the message is exemplified only and may be changeable optionally. Furthermore, an image of item space in which the current preference vector, the estimated direction of preference trend, the recommended direction of item, etc., may be displayed.

Exemplary Preference

In the first embodiment, “+ (plus)” and “− (minus)” are used as as an exemplary notation of preferences of the user to denote attributes (preferences) on which importance is placed, etc. They are however an example only and embodiments are not limited thereto. When the user specifies “+” in a state where items with respect to each area (see FIG. 3) are set as numeric values, for example, an increase by a given value, such as 1, may be made. Specifically, when “safety +” is chosen in a state where “transportation convenience=2 and safety=1” are chosen as a preference of the user, the preference of the user changes to “transportation convenience=2 and safety=2”.

When the user specifies “safety +” in a state where each item is listed in specific examples like those in FIG. 3 and “safety=10 (cases)/year” is chosen as the current preference, areas for which “9 (cases)/year” or smaller is set correspond.

Hardware

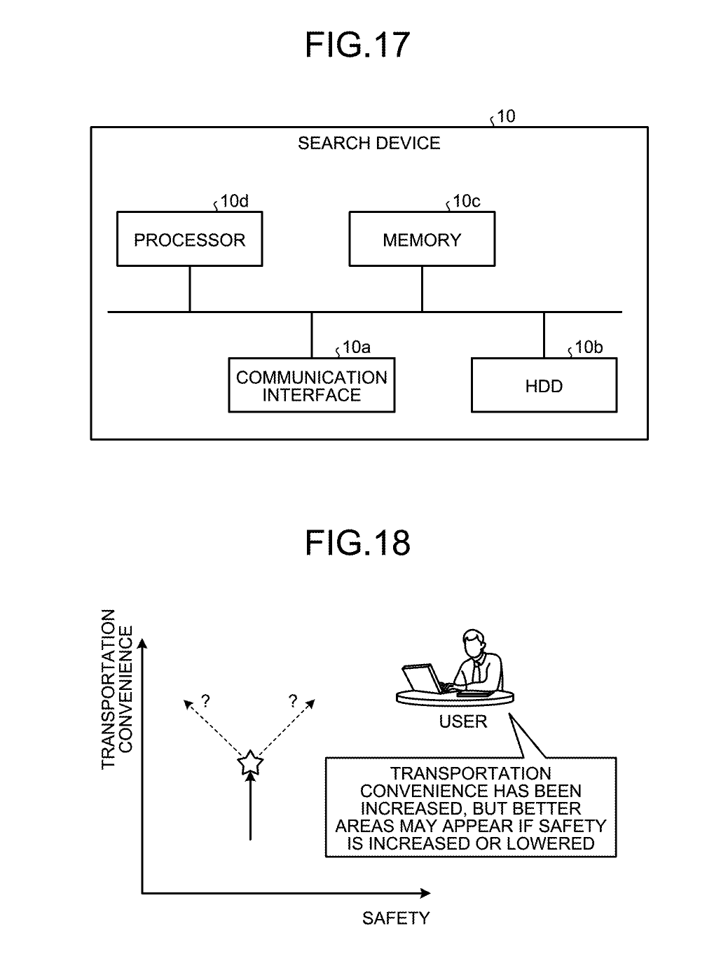

FIG. 17 is a diagram illustrating an exemplary hardware configuration. As illustrated in FIG. 17, the search device 10 includes a communication interface 10a, a hard disk drive (HDD) 10b, a memory 10c, and a processor 10d. The units illustrated in FIG. 17 are connected mutually via a bus, etc.

The communication interface 10a is a network interface card, or the like, and communicates with other servers. The HDD 10b stores programs to implement the functions represented in FIG. 2 and a DB.

The processor 10d reads a program to execute the same processes as those of the respective processors represented in FIG. 2 and loads the program into the memory 10c to run processes to implement the respective functions illustrated with reference to FIG. 2, etc. In other words, the processes implement the same functions as those of the processors of the search device 10. Specifically, the processor 10d reads a program with the same functions as those of the display controller 21, the preference estimator 30, etc., from the HDD 10b, or the like. The processor 10d then executes processes to execute the same processes as those of the display controller 21, the preference estimator 30, etc.

As described above, the search device 10 operates as an information processing device that executes an estimation method by reading and executing the program. The search device 10 may read the above-described program from a recording medium using a medium read device and execute the read program to implement the same functions as those of the above-described embodiment. Programs in other embodiments are not limited to ones that are executed by the search device 10. For example, the present invention may apply also to a case where another computer or another server executes the program or another computer and another server may cooperate to execute the program.

System

The process procedure, control procedure, specific names, information containing various types of data and parameters may be changed optionally unless otherwise noted.

Each component of each device illustrated in the drawings is a functional idea and thus is not always configured physically as illustrated in the drawings. In other words, specific modes of distribution or integration in each device are not limited to those illustrated in the drawings. In other words, all or part of the components may be configured by being distributed or integrated functionally or physically according to a given unit in accordance with various types of load and usage. For example, the processor that displays items and the processor that estimates a preference may be implemented with different chassis. Furthermore, all or any part of the processing functions that are implemented in the respective devices may be implemented by a CPU and a program that is analyzed and executed by the CPU or may be implemented as hardware using a wired logic.

According to the embodiments, it is possible to move forward changing items to display to a user and specifying a user preference together.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
generating a preference trend based on content of a plurality of answers from a respondent for a plurality of inquiries each including a plurality of options;
based on a log of content of representation items that are represented at the plurality of inquiries to the respondent, determining whether information that changes the representation items is to be represented;
generating an input candidate that changes the representation items according to the determining based on the preference trend; and
displaying the input candidate together with the representation items at the plurality of inquiries.

2. The non-transitory computer-readable recording medium according to claim 1, wherein the process further comprises:
displaying, together with the latest representation items, an option that specifies the input candidate that is generated based on the preference trend, among options that respectively specify items to be represented to the respondent, and the number of items that is represented as a result of choosing the option.

3. The non-transitory computer-readable recording medium according to claim 1, wherein the process further comprises:
when there are a plurality of input candidates based on the preference trend, displaying the input candidate that changes the representation items most.

4. The non-transitory computer-readable recording medium according to claim 1, wherein the process further comprises:
determining whether the information that changes the representation items is to be represented when the number of answers from the respondent is equal to or larger than a threshold or when a sum of weight values to be given to the answers from the respondent such that the newer an answer is, the larger a weight value is, is equal to or larger than a threshold.

5. An estimation method comprising:
generating a preference trend based on content of a plurality of answers from a respondent for a plurality of inquiries each including a plurality of options, using a processor;
based on a log of content of representation items that are represented at the plurality of inquiries to the respondent, determining whether information that changes the representation items is to be represented, using the processor; and
generating an input candidate that changes the representation items according to the determining based on the preference trend and displaying the input candidate together with the representation items at the plurality of inquiries, using the processor.

6. An estimation device comprising:
a memory; and
a processor coupled to the memory and the processor configured to:
generate a preference trend based on content of a plurality of answers from a respondent for a plurality of inquiries each including a plurality of options;
based on a log of content of representation items that are represented at the plurality of inquiries to the respondent, determine whether information that changes the representation items is to be represented; and
generate an input candidate that changes the representation items according to a determining result based on the preference trend and display the input candidate together with the representation items at the plurality of inquiries.
